(19) United States
(12) Patent Application Publication
(10) Pub. No.: US 2011/0162589 A1
(43) Pub. Date: Jul. 7, 2011

(54) REUSABLE MEDICAL PROTECTIVE CLOTHING FOR PETS AND FARM ANIMALS AFTER SURGERIES AND WITH SKIN DISEASES

(76) Inventors: Manuela Singer, Niedersachsen (DE); Andrea Singer, Gerlingen (DE)

(21) Appl. No.: 13/057,503

(22) PCT Filed: Jul. 27, 2009
(86) PCT No.: PCT/DE2009/001043

§ 371 Date: Feb. 4, 2011

(30) Foreign Application Priority Data
Aug. 7, 2008 (DE) 202008010513.7
Feb. 6, 2009 (DE) 202009001515.7

(51) Int. Cl. A61D 9/00; A01K 13/00; A44B 13/00

(52) U.S. Cl. 119/855; 119/850; 24/442

(57) ABSTRACT

The invention relates to protective clothing (1) comprising at least one single- or multi-layer outer textile (3) which is non-detachably or detachably connected to a single- or multi-layer inner textile (4) by way of suitable fastening materials, and comprising at least one belly strap (8) and a chest strap (9). The inner textile (4) contains at least one medicinally acting agent (2). A further safety strap (12) may be attached between the chest strap (9) and belly strap (8). All straps can be closed using suitable closure systems (81, 91, 121) such that they can be adjusted in the sizes thereof, and the ends of the belly strap (8) and chest strap (9) can be secured by securing loops (82, 92). An elastic band (10) is attached on both sides at the rear end of the protective clothing (1). The base of the tail (6) and the neck region (7) are exposed. Optional insert pads may be fastened to the inside (1a) of the outer (3) and/or inner textile (4) using suitable fastening means (11) (snap fasteners, Velcro tapes, textile adhesive/tape).

### TECHNICAL FIELD

This invention relates to a washable and reusable protective clothing for pets and farm animals for the treatment of wounds after surgeries and of skin diseases such as neurodermatitis or flea bite hypersensitivity. The inner surface of the protective clothing contains a durable medicinally acting agent (antibacterial, antimycotic, antipruritic).

### BACKGROUND

In veterinary practice, surgery on small animals (castrations, sterilizations, tumor operations, etc.) is conducted very often, particularly on cats and dogs. Furthermore, these animals as well as other pets and livestock frequently suffer from skin diseases, e.g., flea bite hypersensitivity or eczemas, leading to open skin lesions from the animal licking, biting and/or scratching the sore. Unfettered wound healing, both after surgical procedures and in the case of skin diseases, is essential. To date, the state of the art technology to hand would suggest the use of such products as a veterinary recovery collar (hard plastic) (DE69107718T2, DE202006018951U1), muzzle, abdominal bandage or baby body suit for example.

Accordingly in particular for cats and dogs there is no special re-usable protective cloak for use after surgery or in the case of skin diseases to prevent licking the wound or nibbling on the sutures. The bandage materials for dogs in use by veterinary clinics only serve for the initial dressing of the wound. For hygienic reasons they must replace them repeatedly due to the characteristics of the material (bandage material, simple material). In addition there is the risk that the animal will tear off the bandage. Dog coats that are available on the market are usually for fashion or cold protection purposes (US006138611A, US005359963A, DE19819608A1) and are totally unsuitable for cats due to anatomical reasons. One-piece protective clothing designed for dogs, where two (US2004/0031448A1) or four paws (U.S. Pat. No. 6,234,117B1, U.S. Pat. No. 4,355,600, U.S. Pat. No. 3,141,443) must be “inserted” simultaneously is wholly unfit for agile and headstrong animals like cats. Due to the elasticity of these materials (AT008802U1, AT009245U1, US006138611A, U.S. Pat. No. 4,355,600, DE19632336A1, US2004/0031448A1, U.S. Pat. No. 6,234,117B1, U.S. Pat. No. 3,141,443), a) the claws may get stuck in the fabrics, b) in trying to wriggle out of the cloak, the animal may get dangerously caught up in it, and c) grooming of the fur is prevented by the tight, large-scale covering of the body (AT008802U1, DE000009305239U1). The closing mechanisms of various protective cloaks incite cats to play and loosen the ties. They are therefore not suitable to ensure a secure protection of fresh surgical wounds. This is true also of padded elastic support bandages/support clothing (DE19632336A1) and of protective clothing fastened with simple two-piece press studs (AT009245U1), which can be opened by cats. The gaps in the protective clothing in between the various press studs may lead to the animal getting stuck in the clothing or being able to slip it off.

In addition, the use of non-breathable materials does not allow for the wound to be sufficiently supplied with oxygen and may thus negatively affect the healing of the wound. Moreover, the clothing available for dogs (AT008802U1, DE000009305239U1, AT009245U1 bzw. WO2008/014530A1, US006138611A, U.S. Pat. No. 4,355,600, DE10213615A1, US005359963A, EP1857072A2, DE19632336A1, DE19819608A1, DE19632336A1, CA02319885, CA02282216, U.S. Pat. No. 6,481,383B1, US2004/0031448A1, U.S. Pat. No. 6,234,117B1, U.S. Pat. No. 3,141,443) does not have a lining consisting of a medically active fabric, to promote post-operative healing or the healing of skin diseases and which has an antibacterial/antimycotic effect.

Clothing for farm animals (e.g., horses) aims in particular to protect the body of the horse against friction and inflammations resulting from the pronounced hard bulges, caused by the seams joining the various textile layers, of commonly used coverings (DE000009312410U1) or only serves to protect the shins (US2,246,100). This protective clothing, too, does not contain any medically active fabric.

### SUMMARY OF INVENTION

### Technical Problem

The invention specified in protection claim 1 is based on the notion to create reusable protective clothing for cats, dogs and other pets/farm animals, which corresponds to the respective anatomies of the animals, prevents licking or nibbling of the sutures and thus a possible infection of the wound, promotes wound healing by a medically active substance and does not unnecessarily impede the animal in its natural behavior and daily routines.

The main veterinary problems encountered with the present state of the art technology include hitting the neck collar against walls and biting or licking of bandages or wounds. With a recovery collar or muffle, the animals cannot groom themselves. The cone-shaped collar reinforces sounds, which causes additional stress in particular for noise-sensitive animals such as cats and dogs. Both recovery collar and muffle prevent or severely impede the animal's intake of food. In households where more than one pet is kept, the fellow pet's changed appearance with the recovery collar often leads to aggression and fighting among the animals. The collar restricts the function of the whiskers, which are so vital for cats, and may lead to disorientation. These factors contribute to unsettling the sick animal and induce additional stress; this in turn causes secretion of autologous cortisol, and thus per se a slow-down of healing process. Simple bandages can be easily removed by animals. Furthermore, due to an animal's anatomy, it is often not possible to attach the bandages permanently and securely. In addition, such bandages are not reusable and must be replaced frequently for hygienic reasons. For cats, elastic and constricting materials present a severe impediment and high risk of injury. Protracted and complicated attempts to put on (multi-piece) protective clothing may cause an animal to flee, thus preventing a second attempt.

Other protective cloaks developed especially for dogs are not suitable, even dangerous, for other animals and does not contain a lining with medically active substances.

The affected animals spend a large portion of the day trying to get rid of the recovery collar or bandage. In particular the use of unsuitable, misappropriated or provisional wound dressings seldom withstands such attempts. As a result, the animal may manipulate the wound, which often necessitates further veterinary treatments or may even cause severe complications (bleeding/infections).

In many cases, the use of a topical pharmaceutical agent is needed to heal wounds, skin or parasitic diseases. With the present state of the art technology, these active agents can only be applied locally and by using an additional bandage underneath the protective clothing.

### Solution of Problem

The above-mentioned problems can be solved by means of the characteristics featured in the protection claims.

Since the protection cloak corresponds to the anatomy of the respective species, in particular of cats and dogs, it fits animals more comfortably. The cut and size of the protective cloak is determined by the animal's measured spine length and divided into categories. If needed, the protective cloak can also be tailor-made; in this case, the spine length (from tail base to withers/neck) in cm must be measured and provided. There are recesses for the collar and the tail base. The chest strap is designed as narrowly as possible to ensure that it will not the animal while walking and to ensure that cats in particular can groom their front legs and chest. The abdominal strap is correspondingly wide to cover up any abdominal operation scars and to prevent slipping of the protective cloak. If required, an additional securing strap can be attached between the abdominal strap and the chest strap; this ensures, where necessary, an additional fixing of the protective cloak. To prevent the animals from getting rid of the suit, at the rear end an additional 3-50 mm wide elastic strap is attached on both sides. This strap passes around the hind legs.

The fastenings (neck/chest and abdomen) can be designed in Velcro and/or as snap/three-pronged clasps, which can be open or closed very quickly yet securely. In particular when using Velcro fasteners, the end of the straps is secured by one or more loops. The optional securing strap between the chest and abdominal strap is sowed on to the chest strap and is attached by means of a snap/side-release buckle to the abdominal strap.

The fastening system may consist of a contoured side-release buckle fastened to the fabric (female part) and a male part, a contoured side-release buckle with a sow-on female part and a male part and/or a sow-on loop tape and hook tape (10-150 mm, hook-and-loop fastener). Depending on the selected fastening system (contoured side-release buckles and variable length of the hook-and-loop components) all straps can be adjusted to the animal's girth.

Two-part hook-and-loop fasteners, consisting of a loop fabric (loop tape) and a hook fabric (hook tape), which can be force joined by light pressure and stick to each other in an extensive yet detachable manner, are state of the art. To ensure the adjustability of the strap, the loop tape and/or the opposite hook tape are designed in strips with a length dimension of the strap of 2 to 30 cm, preferably 5 to 20 cm.

Another advantageous development is the design of the fasteners as interlocking side-release buckles and/or snap clasps. They consist of a receptive part (female) and a corresponding insertion part (male). That receptive part and/or the insertion part are elastically malleable so that both parts can be joined in an interlocking, releasable manner. For length adjustment, either a receptive part or an insertion part can be attached by means of a familiar variable loop holder to any of the straps.

The single or multi-layered upper fabric of the protective cloak can be attached to the single or multi-layered lining in a detachable or permanent manner. For the permanent version, the upper fabric and the inside fabric are sowed or stitched together flush at the edge of the cutting pattern, and possibly at various fixing points within the pattern. For the detachable version, which makes it possible to wash the lining separately, the upper textile is attached to the lining at the edge and/or in the middle of the cutting pattern by means of suitable detachable fasteners, e.g., a circumferential zipper, press studs and/or hook-and-loop fasteners. Zippers, metal or synthetic plastic press studs and hook-and-loop fasteners, which enable the speedy attachment of two (textile) components, are state of the art. When using press studs or hook-and-loop fasteners, the cutting pattern of the lining is approximately 1-2 cm smaller at the edge than the cutting pattern of the upper fabric; accordingly the upper fabric protrudes beyond the rim of the lining by about 1-2 cm. This makes it impossible for the animals to reach into the gaps between the individual fastening points. Accordingly animals cannot get stuck in or wriggle out of the protective cloak.

The lining of the protective cloak, which is in direct contact with the skin or fur, consists of a single or multi-layered material containing a specifically antibacterial/antimycotic material (silver textile or similar) that is conducive to wound healing and alleviates itches. The antimicrobial effects of metal ions, such as Ag, Au, Pt, Pd, Ir (i.e. precious metals), Cu, Sn, Sb, Bi and Zn are well-known (Morton, H. E., Pseudomonas in Disinfection, Sterilization and Preservation, Hrsg. S. S. Block, Lea und Febiger, 1977; Grier, N., Silver and Its Compounds in Disinfection, Sterilization and Preservation, Hrsg. S. S. Block, Lea und Febiger, 1977). Among the metal ions with antimicrobial characteristics silver is most well-known due to its exceptionally good organic activity in low concentrations. This phenomenon is described as oligodynamic effect. In the modern medical practice mineral as well as organic soluble salts of silver are used to prevent and treat microbial infections.

Silver textiles are state of the art. Silver oxidizes with the skin's heat and moisture. This ensures that the silver ions are quickly absorbed by the body and thus an optimal effect. The silver ions are released by the body heat and moisture in the skin. Bacteria are negatively charged, silver is positively charged; this causes a magnetic attraction which causes the bacteria to be enclosed by the silvers, and thus to be deactivated. Silver coated materials show a clear antibacterial effect vis-à-vis the following bacteria: staphylococcus aureus, pseudomonas aeruginosa and candida albicans (Gauger A et al. Efficacy and functionality of silver-coated textiles in patients with atopic eczema. JEADV 2006; 18,534-541; Prof. Dr. Dietrich Abeck, Reduction of Staphylococcus aureus colonization by Padycare® silver coated textiles in patients with atopic eczema).

While wearing silver textiles, a rapid decline of the classical symptoms of neurodermatitis, atopical dermatitis and/or endogenous eczemas has been observed. The antimicrobial effect reduces the number of germs on the skin within a few days; the distinct antibacterial and antimycotic effect is proven.

Pharmaceutical active agents, selected from the group consisting of bactericides, virucides, antibiotics, antimycotics, antiallergenics, antiparasitics, silver and silver alloys can be applied directly onto the washable and reusable lining or can be integrated directly into the lining. The medical agents can be applied either by means of an ointment, powder, talcum, a cream or gel, or by means of a coating (solution, foil or similar). Especially in the case of severely oozing wounds, a supplementary individual interlining fabric (pad) can be attached optionally to the upper fabric or to the lining attached (detachably or permanently) to the upper fabric; this pad can be replaced as needed due to suitable fastening devices (e.g., press studs, hook-and-loop fasteners, or non-stick textile adhesives or straps). This additional interlining fabric/pad (silver textile, cotton—coated—if necessary, synthetic polymer fibers, viscose or sheep wool) can fixed extensively between the particularly operated areas and the lining of the protective cloak by means of fasteners to provide additional protection with medical effect on any wound or operated area. This interlining fabric/pad can be replaced at any time by a fresh interlining fabric/pad and thus ensures simple cleaning and reuse of the used interlining fabrics/pads. Due to optimal wound healing, the cloak can be removed sooner; the alleviation of itching prevents attempts to nibble the wound. The medical effectiveness of the lining/interlining fabric/pad ensures the antiseptic/antimycotic covering of the wound/affected skin area. In addition, selected other pharmaceutically active agents (see above) can be applied. The silver threads/particles in particular do not lose their medical effectiveness even after multiple washing and can therefore be used repeatedly and for other pets in the household.

The upper fabric consists of a single or multi-layered, breathable, water-proof and washable fabric made of cotton fibers—coated if necessary, synthetic polymer fibers, sheep wool or viscose; its breathable properties contribute to sufficient airing of the wound and the affected skin, which is essential for an optimal healing process. In general, the breathable properties of the upper fabric may rely on two functional principles:
1. The moisture can escape through small pores, which are big enough to permit the penetration of water vapor, but too small for water drops and thus keep out water drops (microporous fabrics). During manufacture, at first, a water-proof membrane is produced separately and afterwards laminated on to a carrier tissue (usually polyamide/PA polyamide/PA or polyester/PES polyester/PES) or “hung,” between upper fabric and lining (Z lining).
2. Water vapor molecules are transported away by electro-chemical processes. The molecules are absorbed and permeate through the water-proof material (compact materials, not to be confused with compact coating!). With this functional principle, a coating, usually made of polyurethane, is applied directly on to the carrier tissue. Furthermore the durable and water-proof properties of the upper fabric allows the animal to be outdoors, while protecting the wound from contamination by penetrating water and other environmental influences. The manufacture of water-proof fabrics, the mechanical insertion of water-proof materials or the application of film forming substances (fluorine, silicone) improves the pearling effect of water. This feature is gradually reduced over time or due to rubbing or washing, thus requiring a repeat of the impregnation process.

Since in the case of protective cloak—unlike a recovery collar—the wound is covered and not accessible, it is also an effective mechanical protection against parasites (e.g., flies). To ensure that the suit does not irritate the animal too much, a light-weight, breathable yet stable material is used, which does not impede the animal, while providing mechanical protection against licking, scratching and biting at the same time. Also in the case of flea bite hypersensitivity it is essential that the animal is not able to lick or nibble the flea bites.

### Advantageous Effects of Intervention

This invention makes redundant the use of recovery collars/muzzles or unsuitable makeshift solutions for postoperative care/treatment of skin diseases of pets and livestock. For cats in particular, currently only recovery collars are available. The cut of the protection cloak is adapted to the respective anatomical peculiarities and needs of the animal; thus a firm fit is ensured and shedding of the cloak is prevented. The natural behavior and daily routine of the animal is impeded in the smallest measure, which contributes to a speedy recovery and healing. The mechanically stable, water-proof, breathable external coating of the invention prevents manipulation of the wound or bandage; the medically active inside lining/interlining fabric/pad of the protective cloak promotes the healing process. Due to its material properties, the protective cloak is durable, washable and reusable. It can be washed without losing its primary medical properties and presents also from a hygienic point of view an optimal wound treatment. Due to the above-mentioned properties, the protective cloak can also be used for other animals in the household. This also presents an environmental benefit. The optional additional use of a securing strap between the chest strap and the abdominal strap as well as the easy replacement of the optional medically effective interlining fabric/pad enhances the practicability and scope of application of the invention even for problem cases.

### BRIEF DESCRIPTION OF DRAWINGS

Further details of the invention can be derived from the following detailed description and the enclosed drawings. Execution versions of the invention are described below with reference to the enclosed drawings. The drawings show:

FIG. 1a: a schematic representation of a cat wearing the protective clothing;

FIG. 1b: a schematic representation of a cat wearing an additional protective clothing (additional securing strap between the chest strap and the belly strap);

FIG. 2a: a view from above of the outspread outer layer of the protective clothing shown in FIG. 1a;

FIG. 2b: a view from above of the outspread outer layer of the protective clothing shown in FIG. 1b;

FIG. 3a: a cross-section of the protective cloak with optional inlay textile/-pad in the version with permanently joined inside lining and upper textile;

FIG. 3b: a cross-section of the protective clothing with optional inlay textile/-pad in the version with detachable attachment of inside lining to upper textile;

FIG. 4a: a view from above of the inside layer of the protective clothing shown in FIG. 1 in the version of detachable attachment of inside lining and upper textile by means of Velcro fasteners;

FIG. 4b: a view from above of the inside layer of another protective clothing shown in FIG. 1 in the version of detachable attachment of inside lining and upper textile by means of snap fasteners and Velcro fasteners;

FIG. 4c: a view from above of the inside layer of another protective clothing shown in FIG. 1 in the version of detachable attachment of inside lining and upper textile by means of a zip fastener.

### DESCRIPTION OF THE PREFERRED EMBODIMENTS

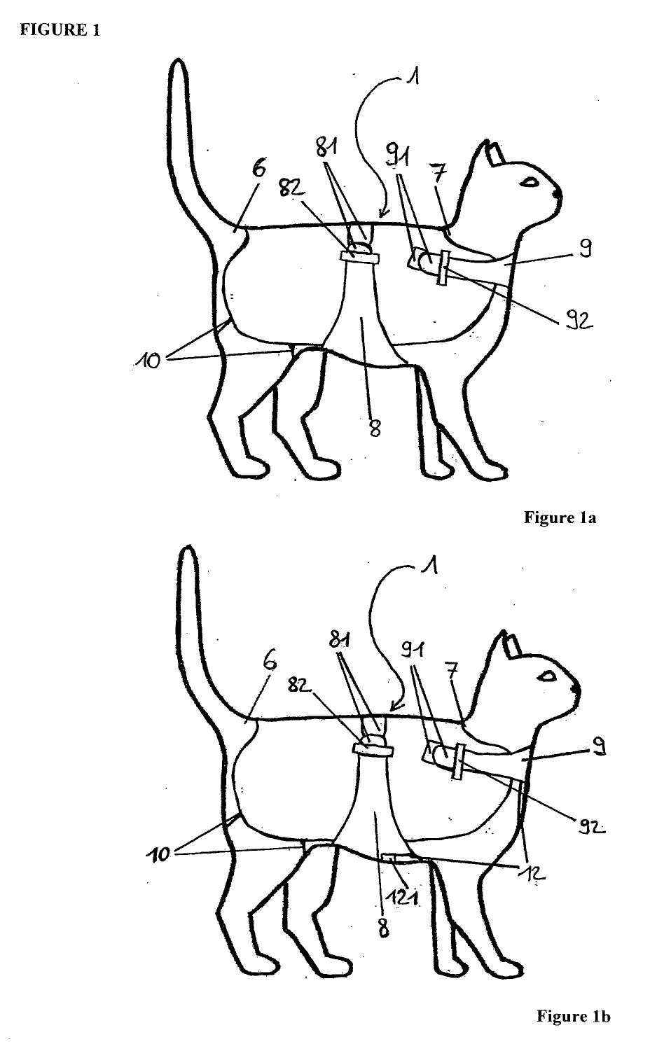

In FIG. 1, a side view of the protective clothing (1) is shown, comprising at least one single- or multi-layer outer textile (3) which is non-detachably or detachably connected to a single- or multi-layer inner textile (4) by way of suitable fastening materials, and comprising at least one belly strap (8) and a chest strap (9). The inner textile (4) contains at least one medicinally acting agent (2). A further safety strap (12) may be attached between the chest strap (9) and belly strap (8) (FIG. 1b). All straps can be closed using suitable closure systems (81, 91, 121) such that they can be adjusted in the sizes thereof, and the ends of the belly strap (8) and chest strap (9) can be secured by securing loops (82, 92). An elastic band (10) is attached on both sides at the rear end of the protective clothing (1).

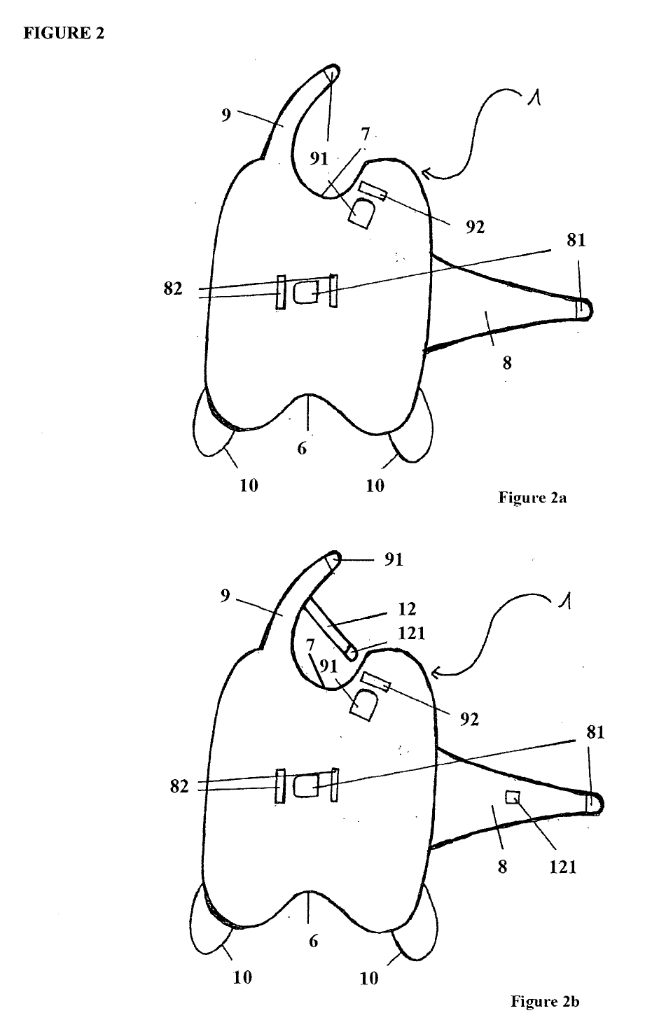

The pattern 5 of the protective clothing (1) shown in FIG. 1, which is illustrated in FIG. 2, comprises at least one single- or multi-layer outer textile (3) which is non-detachably or detachably connected to a single- or multi-layer inner textile (4) by way of suitable fastening materials, and comprising at least one belly strap (8) and a chest strap (9). A further safety strap (12) may be attached between the chest strap (9) and belly strap (8) (FIG. 2b). All straps can be closed using suitable closure systems (81, 91, 121) such that they can be adjusted in the sizes thereof, and the ends of the belly strap (8) and chest strap (9) can be secured by securing loops (82, 92). An elastic band (10) is attached on both sides at the rear end of the protective clothing (1). The base of the tail 6 and the neck region 7 are exposed.

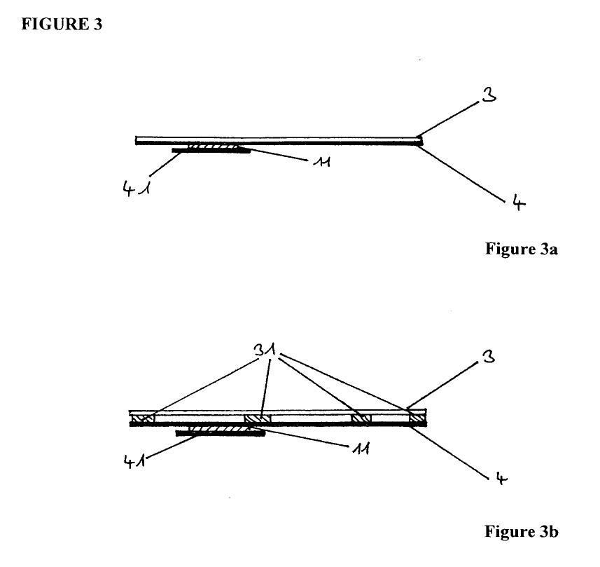

FIG. 3 is a cross-sectional view of the protective clothing 1 shown in FIG. 1, comprising at least one single- or multi-layer outer textile 3 which is non-detachably or detachably connected to a single- or multi-layer inner textile 4 by way of suitable fastening materials, and comprising at least one belly strap 8 and a chest strap 9. Optional insert pads 41 may be fastened to the inside (1a) of the outer 3 and/or inner textile 4 using suitable fastening means 11 (snap fasteners, Velcro tapes, textile adhesive/tape).

In a further advantageous version with detachable connection between outer textile 3 and inner textile 4, the outer textile 3 is attached—as shown in FIG. 3b—by means of suitable fastening devices (circumferential zipper, press studs and/or hook-and-loop fasteners) to the inner textile 4 in a detachable manner.

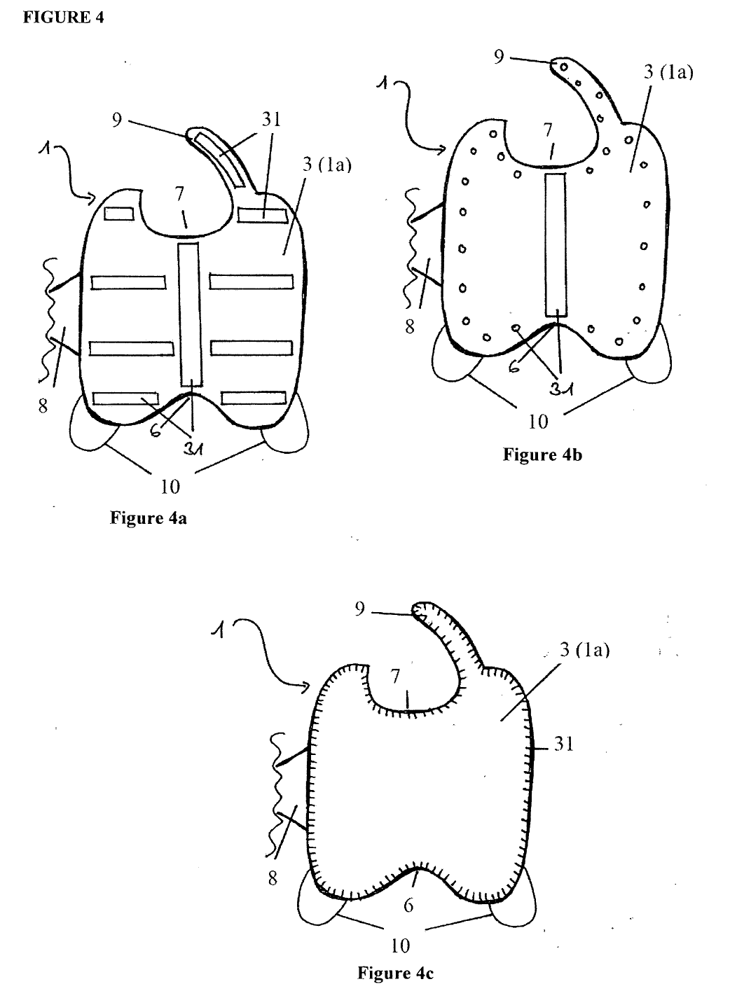

FIG. 4 shows the cutting pattern of the view from above of the inside 1a of the outer textile 3 of the protective clothing, as shown in FIG. 1, comprises at least on single or multi-layered outer textile 3, which is attached in a detachable manner to a single or multi-layered inner textile 4 by means of suitable fastening means 31, and which has at least one belly strap 8 and a chest strap 9.

In a further advantageous version with detachable connection between outer textile 3 and inner textile 4, the inside 1a of the outer textile 3 is attached—as shown in FIG. 4a—to the inner textile 4 by means of Velcro fasteners in a detachable manner.
In a further advantageous version with detachable connection between outer textile 3 and inner textile 4, the inside 1a of the outer textile 3 is attached—as shown in FIG. 4b—to the inner textile 4 by means of snap fasteners and Velcro fasteners 31 in a detachable manner.
In a further advantageous version with detachable connection between outer textile 3 and inner textile 4, the inside 1a of the outer textile 3 is attached—as shown in FIG. 4c—to the inner textile 4 by means of a circumferential zipper in a detachable manner.

### REFERENCE SIGNS LIST

1 Protective clothing
1a Inside of the outer or inner textile
2 Medicinally acting agent
3 Outer textile
4 Inner textile (silver textile/silver particles)
5 Pattern
6 Cut-out of base of the tail
7 Cut-out of neck region
8 Size-adjustable belly strap
9 Size-adjustable chest strap
10 Elastic hind limb bands/Elastic band
11 Fastening means (snap fasteners, Velcro tapes, textile adhesive/tape)
12 Safety strap between chest strap and belly strap
121 Detachable closure system for connection strap between chest strap and belly strap
31 Fastening means (between inner- and outer textile: snap fasteners, Velcro tapes, zip fasteners)
41 Inlay textile/-pad (silver textile/silver particles)
81 Detachable closure systems (belly strap)
91 Detachable closure systems (chest strap)
82 Securing loop (belly strap)
92 Securing loop (chest strap)

### CITATION LIST

### Patent Literature

| | | |
|---|---|---|
| AT008802U1 | October 2005 | Freitag |
| AT009245U1 | April 2006 | Freitag |
| CA02282216 | September 1999 | McGee et al. |
| CA02319885A1 | September 2000 | McGee et al. |
| DE000009305239U1 | April 1993 | Friedmann |
| DE000009312410U1 | August 1993 | Mettenborg |
| DE10213615A1 | March 2002 | O'Reilly |
| DE19632336A1 | August 1996 | Sönke Strzybny |
| DE19819608A1 | May 1998 | Sönke Strzybny |
| DE202006018951U1 | December 2006 | Schwarz et al. |
| DE20311220U1 | July 2003 | Nitsche |
| DE69107718T2 | July 1991 | Fick et al. |
| US005341765A | May 1993 | McComb |
| US005359963A | December 1993 | Jesse et al. |
| US006138611A | November 1999 | Thielemann |
| U.S. Pat. No. 2,246,100 | May 1939 | Marzani |
| US2004/0031448A1 | July 2003 | Trepanier |
| US2004/0244725A1 | May 2003 | Hartman et al. |
| U.S. Pat. No. 3,141,443 | July 1963 | Huey |
| U.S. Pat. No. 4,355,600 | December 1980 | Zielinski |
| U.S. Pat. No. 6,234,117 B1 | July 1999 | Spatt |
| U.S. Pat. No. 6,481,383 B1 | September 2000 | Ross et al. |
| U.S. Pat. No. 6,880,489 B2 | May 2003 | Hartman et al. |
| WO2008/014530A1 | July 2007 | Freitag |

### NON PATENT LITERATURE

Gauger A et al. Efficacy and functionality of silver-coated textiles in patients with atopic eczema. JEADV 2006; 18,534-541
Prof. Dr. Dietrich Abeck, Reduction of Staphylococcus aureus colonization by Padycare° silver coatet textiles in patients with atopic eczema
Morton, H. E., Pseudomonas in Disinfection, Sterilization and Preservation, Hrsg. S. S. Block, Lea und Febiger, 1977
Grier, N., Silver and Its Compounds in Disinfection, Sterilization and Preservation, Hrsg. S. S. Block, Lea und Febiger, 1977

What is claimed is:

1. Protective clothing (1) for pets and farm animals after surgeries and in case of skin diseases, wherein the protective clothing (1) is designed with single or multiple layers and has a lining (1a) which is equipped partially or entirely with a medically acting agent (2).

2. Protective clothing (1) as defined in claim 1, wherein the agent (2) contains one or several pharmaceutical agents selected from the group consisting of bactericides, virucides, antibiotics, antimycotics, antiallergenics, antiparasitics, silver and silver compounds.

3. Protective clothing (1) as defined in claim 1 or 2, wherein it comprises a single- or multiple-layered upper textile (3) and a single- or multiple-layered inner textile (4).

4. Protective clothing (1) as defined in claim 3, wherein it has fastening devices (31) for detachable connection of the inside textile (4) to the upper textile (3) which are preferably designed as snap fasteners, Velcro tapes or zip fasteners.

5. Protective clothing (1) as defined in one or more of claims 1 to 4, wherein said it comprises an inlay textile/-pad (41) and fastening means (11) for detachable connection of the inlay textile/-pad (41) to the lining (1a) of the protective clothing (1) in which the fastening means (11) are preferably designed as snap fasteners or Velcro tapes, or consist of detachable textile adhesive or textile adhesive tape.

6. Protective clothing (1) as defined in claim 3, 4 or 5, wherein the inner textile (4) and/or the inlay textile/-pad (41) contains silver threads or silver particles.

7. Protective clothing (1) as defined in one or more of claims 3 to 6, wherein the upper textile (3) consists of breathable, water-proof and washable fabric, in particular of synthetic polymer fibers.

8. Protective clothing (1) as defined in one or more of claims 3 to 6, wherein the upper textile (3) consists of cotton fibers, sheep wool or viscose, which is coated if necessary.

9. Protective clothing (1) as defined in one or more of claims 1 to 8, wherein the cutting pattern (5) is adapted to the anatomy of an animal, selected from the group of pets and farm animals, in particular cats, dogs, pigs, horses, cows, goats, sheep and reptiles.

10. Protective clothing (1) as defined in claim 9, wherein the base of the tail (6) and the neck region (7) of the animal is exposed.

11. Protective clothing (1) as defined in one or more of claims 1 to 10, wherein it comprises a size-adjustable belly strap (8), a size-adjustable chest strap (9) and elastic hind leg loops (10).

12. Protective clothing (1) as defined in claim 11, wherein it has a securing strap (12), which is intended to connect the chest strap (9) to the belly strap (8).

13. Protective clothing (1) as defined in claim 11 or 12, wherein it has securing loops (82, 92) for the belly strap (8), and the chest strap (9).

14. Protective clothing (1) as defined in claim 11, 12 or 13, wherein it has detachable closure systems (81, 91, 121) for the belly strap (8), the chest strap (9), and the securing strap (12).

15. Protective clothing (1) as defined in claim 14, wherein the closure systems (81, 91, 121) are designed to be opened or closed quickly, in particular as Velcro tape or as a side-release buckle/snap clasp.
